(19) United States
(12) Patent Application Publication
(10) Pub. No.: US 2023/0080872 A1
(43) Pub. Date: Mar. 16, 2023

(54) PROACTIVE ADJUSTMENT BASED ON NETWORKING IMPACT RELATED EVENT

(71) Applicant: Cisco Technology, Inc., San Jose, CA (US)

(72) Inventors: Sebastian Jeuk, Muenchen (DE); Carl Peter M. R. Charpentier, Confignon (CH)

(21) Appl. No.: 17/476,821

(22) Filed: Sep. 16, 2021

(51) Int. Cl. H04L 12/24

(52) U.S. Cl. CPC H04L 41/0816; H04L 41/147

(57) ABSTRACT

In one example, one or more devices monitor one or more data feeds from one or more sources of updates regarding networking impact related events for an indication that one or more networking impact related events are occurring or will occur. Based on the one or more data feeds, the device(s) determine that a networking impact related event of the one or more networking impact related events is occurring or will occur in a geographic region. In response to determining that the networking impact related event is occurring or will occur in the geographic region, the device(s) automatically identify one or more target adjustments to a network and/or to one or more services provided over the network. The device(s) implement the one or more target adjustments to the network and/or to the one or more services provided over the network.

### TECHNICAL FIELD

The present disclosure relates to computer networking.

### BACKGROUND

Networking impact related events can disrupt service to users. For example, a natural disaster such as an earthquake could damage servers that host a website, thereby preventing users from accessing the website. Or a sporting event or concert where a large number of attendees are gathered in a relatively small space could lead to inadequate telecommunications resources to support the attendees.

### BRIEF DESCRIPTION OF THE DRAWINGS

FIG. 1 illustrates a system configured to provide one or more proactive target adjustments based on a networking impact related event that is occurring or will occur in a geographic region, according to an example embodiment.

FIG. 2 illustrates a functional workflow for providing an indication of one or more proactive target adjustments based on a networking impact related event that is occurring or will occur in a geographic region, according to an example embodiment.

FIG. 3 illustrates a functional workflow in a Secure Access Service Edge (SASE) use case for providing an indication of one or more proactive target adjustments based on a networking impact related event that is occurring or will occur in a geographic region, according to an example embodiment.

FIG. 4 illustrates a hardware block diagram of a computing device configured to perform functions associated with operations discussed herein, according to an example embodiment.

FIG. 5 illustrates a flowchart of a method for performing functions associated with operations discussed herein, according to an example embodiment.

### DESCRIPTION OF EXAMPLE EMBODIMENTS

### Overview

Techniques are provided for making one or more proactive adjustments based on a networking impact related event. In one example embodiment, one or more devices monitor one or more data feeds from one or more sources of updates regarding networking impact related events for an indication that one or more networking impact related events are occurring or will occur. Based on the one or more data feeds, the device(s) determine that a networking impact related event of the one or more networking impact related events is occurring or will occur in a geographic region. In response to determining that the networking impact related event is occurring or will occur in the geographic region, the device(s) automatically identify one or more target adjustments to a network and/or to one or more services provided over the network. The device(s) implement the one or more target adjustments to the network and/or to the one or more services provided over the network.

### Example Embodiments

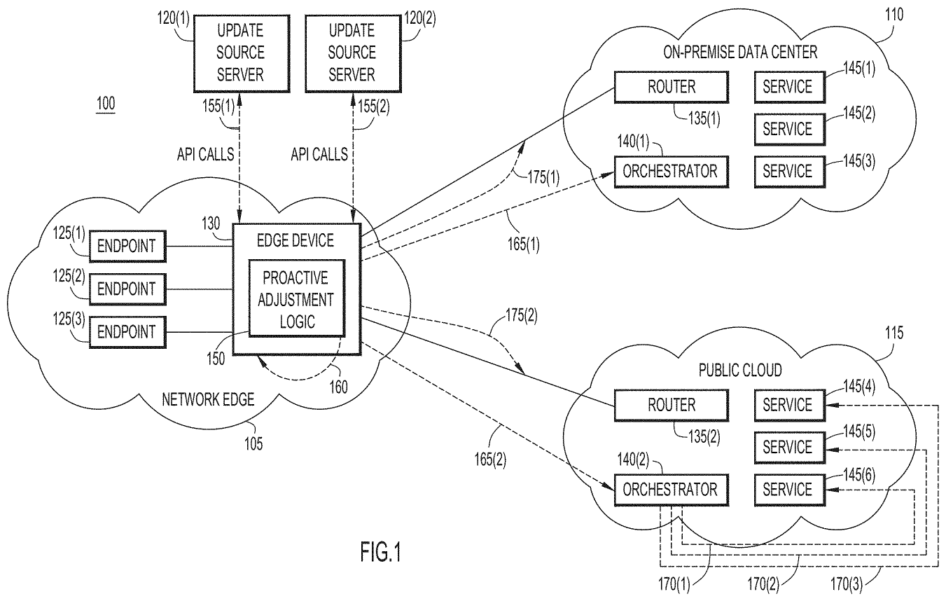

FIG. 1 illustrates an example system 100 configured to provide one or more proactive target adjustments based on a networking impact related event that is occurring or will occur in a geographic region. System 100 includes network edge 105, on-premise data center 110, public cloud 115, and update source servers 120(1) and 120(2). Network edge 105 includes endpoints 125(1)-125(3) and edge device (e.g., edge router) 130. On-premise data center 110 includes router 135(1), orchestrator 140(1), and services 145(1)-145(3). Public cloud 115 includes router 135(2), orchestrator 140(2), and services 145(4)-145(6).

In a conventional system, when a networking impact related event occurs, the system might not become aware of the event until after the event has meaningfully impacted system performance. However, relying on the network to reflect the specific patterns of a networking impact related event is not sufficient or reliable because the system would react to the event only after the event has significantly diminished user experience and/or security. Examples of networking impact related events may include natural or man-made disasters (e.g., earthquakes, floods, etc.), sporting events, concerts, elections, etc.

Accordingly, in order to enable system 100 to proactively implement adjustments in response to networking impact related events, edge device 130 is provided with proactive adjustment logic 150. In one example, proactive adjustment logic 150 causes edge device 130 to monitor one or more data feeds from update source servers 120(1) and 120(2) for an indication that one or more networking impact related events are occurring or will occur. Update source servers 120(1) and 120(2) may be any suitable sources of updates regarding networking impact related events, such as social media servers, news servers, emergency response channel servers, or any other suitable external sources that can indicate the occurrence of a networking impact related event. The updates may be based on spiking cell usage, emergency frequency usage, social media hashtags, social media events, breaking news, etc. As represented by arrows 155(1) and 155(2), edge device 130 may monitor the data feeds by making Application Programming Interface (API) calls to update source servers 120(1) and 120(2).

Based on the data feeds, proactive adjustment logic 150 may cause edge device 130 to determine that a networking impact related event is occurring or will occur in a geographic region. Edge device 130 may determine that the networking impact related event is occurring or will occur based on the data feeds before edge device 130 would have based on conventional methods, e.g., in response to a meaningful impact on system performance. This may enable edge device 130 to implement adjustments to a network and/or to one or more services provided over the network (e.g., services 145(1)-145(6)) before the networking impact related event significantly diminishes user experience and/or security.

In particular, in response to determining that the networking impact related event is occurring or will occur in the geographic region, proactive adjustment logic 150 may cause edge device 130 to automatically identify one or more target adjustments to the network and/or to one or more of services 145(1)-145(6). When implemented, the target adjustments may modify handling of network traffic within or outside the network and/or the geographic region. The one or more target adjustments may include any suitable adjustment(s), such as a target introduction or relocation of a security function (e.g., one or more of services 145(1)-145(6)) configured to process the network traffic, other security modifications, network traffic re-routing, traffic shaping, or any other suitable changes configured to influence network behavior appropriately. The target adjustments may include recommendations or suggested adjustments desired/required by users of endpoints 125(1)-125(3) in the geographic region impacted by the networking impact related event. In one example, as represented by arrow 160, proactive adjustment logic 150 may inform edge device 130 of the one or more recommendations/adjustments to cope with the networking impact related event.

Proactive adjustment logic 150 may further cause edge device 130 to implement the one or more target adjustments to the network and/or to one or more of services 145(1)-145(6). In one example, as represented by arrows 165(1) and 165(2), edge device 130 may provide the indication of the one or more target adjustments to orchestrators 140(1) and 140(2). Orchestrators 140(1) and 140(2) may include processes that execute the one or more target adjustments. For example, as represented by arrows 170(1)-170(3), orchestrator 140(2) may react based on the target adjustments by providing additional service capabilities in public cloud 115; moving services 145(4)-145(6) closer to network edge 105 to guarantee fast connectivity; or any other necessary or desired adjustments to enable the users or endpoints 125(1)-125(3) coping with the networking impact related event to use services 145(4)-145(6) with the best possible performance. Orchestrator 140(1) in on-premise data center 110 may perform similar operations with respect to services 145(1)-145(3).

In another example, as represented by arrows 175(1) and 175(2), edge device 130 may adjust link or routing details to forward network traffic based on the one or more target adjustments. For instance, edge device 130 may change bandwidth, select links with better latency, re-route traffic to avoid areas that are impacted by the networking impact related event, etc. In a further example, edge device 130 may enable in-band policy adjustment based on the networking impact related event. Edge device 130 may translate the networking impact related event into a set of rules that describe the event and an impact of the event. Edge device 130 may transmit (or cause to be transmitted) the set of rules in-band (e.g., through metadata-enabled header(s) of one or more network packets). Devices in the path of the network packets may react to the details shared in-band and autonomously/automatically adjust policies. For example, the in-band metadata may prompt a firewall to adjust security rules enforced by that firewall. Other examples may be envisioned.

In one example, system 100 may be a Secure Access Service Edge (SASE) environment. SASE may provide an architecture approach to dynamically delivering “as a service” security functions (e.g., service 145(1)-145(6)) to endpoints 125(1)-125(3) at network edge 105. In this example, system 100 may define a dynamic use of services 145(1)-145(6) across on-premise data center 110 and public cloud 115. Edge device 130 may ensure that adequate security measures are followed at network edge 105 by determining when the demand for security changes and prompting system 100 to adapt accordingly. Edge device 130 may use the data feeds obtained from update source servers 120(1) and 120(2) to influence the dynamic behavior of system 100. Thus, edge device 130 may integrate external data feeds into the dynamic provisioning (e.g., auto-scaling) of “as a service” security functions (e.g., service 145(1)-145(6)) within system 100.

Proactive adjustment logic 150 may be integrated into system 100 as a function on edge device 130 and/or in any other suitable device(s)/location(s) within a network (for example, proactive adjustment logic 150 may also run “as a service” in public cloud 115). Integrating proactive adjustment logic 150 into edge device 130 may allow edge device 130 to detect networking impact related events in a certain geographic region, specific to system 100 or the “as a service” security functions running in on-premise data center 110 and/or public cloud 115 (e.g., service 145(1)-145(6)). Edge device 130 may further dynamically adjust security capabilities (e.g., services 145(1)-145(6)) at network edge 105 based on networking impact related events.

In one specific example, edge device 130 detects an upcoming sporting event and, in response, recommends switching from services 145(4)-145(6) in public cloud 115 to services 145(1)-145(3) in on-premise data center 110. Services 145(4)-145(6) in public cloud 115 may be cheaper and easier to deploy, but offer limited security functionality; during the sporting event, it may be preferable to use services 145(1)-145(3), which may be more heavyweight, provide better encryption capabilities, and offer additional security functionality. As a result, to ensure system 100 can cope with the sporting event, edge device 130 may prompt a change in security by switching from the basic security capabilities offered by public cloud 115 to the additional/higher security capabilities offered by on-premise data center 110. For example, edge device 130 may identify a target introduction or relocation of a security function (e.g., one or more of services 145(1)-145(6)) to enable the switchover. Edge device 130 may also prompt a change in forwarding by causing network traffic to be re-routed from services 145(4)-145(6) on public cloud 115 to services 145(1)-145(3) in on-premise data center 110. Thus, edge device 130 may influence the dynamics of system 100 by forwarding traffic to the desired/needed “as a service” security functions (e.g., services 145(1)-145(3)).

The networking impact related event does not necessarily cause edge device 130 to reduce security, but may influence how security is provided while the networking impact related event is ongoing. As a result, security need not be sacrificed: the target adjustments may indicate the appropriate level of security, how corresponding security functions can be reached, the potential scale of the required security functions, etc. Because certain networking impact related events may require elevated security, edge device 130 may adjust parameters (e.g., scaling, forwarding, etc.) to continue providing the required security capabilities in an area with modified network behavior/load.

As one consequence of proactive adjustment logic 150, edge device 130 may dictate the use of a security function that has not been previously offered to a specific geographic region or group of end-users. Edge device 130 may also ensure that security functions remain reachable, particularly if the networking impact related event demands quick, undisruptive access to the security functions. In addition, edge device 130 may control security function orchestration/deployment, for example, when the networking impact related event requires a set of “as a service” security functions to be deployed in close proximity to network edge 105.

In a further example, edge device 130 may communicate with multiple SASE environments at the same time, to enable modifications to network traffic handling for users registered to SASE providers based outside the geographic region where the event is occurring or will occur. Edge device 130 may track user location using any suitable method, such as based on 5G cell associations (e.g., phone and address).

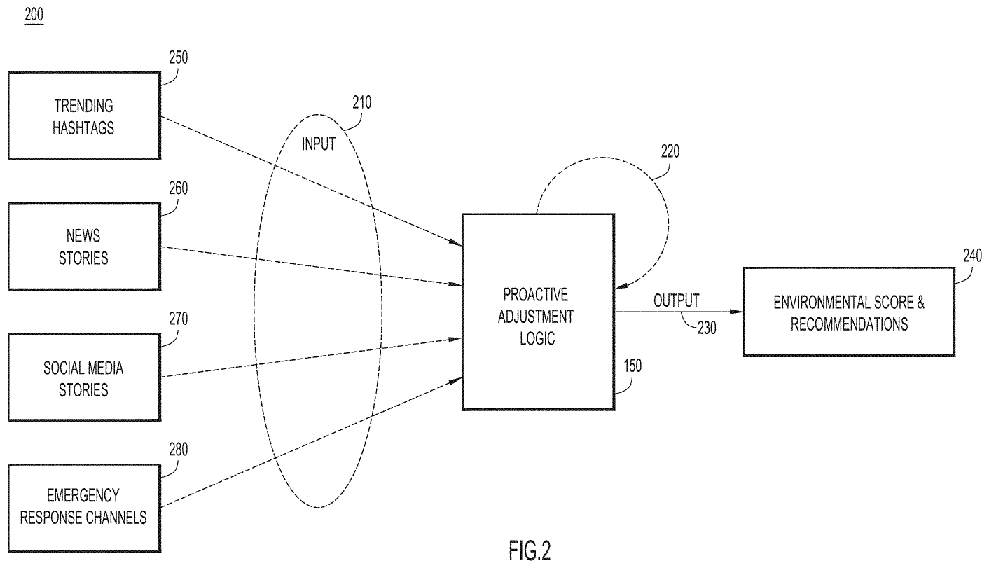

With continuing reference to FIG. 1, FIG. 2 illustrates an example functional workflow 200 for providing an indication of one or more proactive target adjustments based on a networking impact related event that is occurring or will occur in a geographic region. As shown, proactive adjustment logic 150 obtains input 210, processes the input using feedback loop 220, and provides output 230 in the form of environmental score and recommendations 240. Input 210 may include data feeds based on trending hashtags 250 (e.g., the top-k hashtags on a social media service), news stories 260, social media stories 270, and emergency response channels 280. Input 210 may include any suitable information relevant to trending stories in a particular geographic region.

Based on the data feeds, proactive adjustment logic 150 may calculate/compute a score (e.g., an environmental score) that reflects/indicates a level of criticality or impact associated with a networking impact related event that is occurring or will occur in a network in a geographic region. For example, proactive adjustment logic 150 may take the top-k stories into consideration to define the score, which may indicate the impact of the networking impact related event on endpoints 125(1)-125(3). The score may be between 0 and 10, where a score of 0 indicates that the event does not have any impact on a network and a score of 10 indicates that the event has a high impact on endpoints 125(1)-125(3).

Proactive adjustment logic 150 may continue to monitor the data feeds after computing the score and, in response, adjust the score. For example, if input 210 indicates that a networking impact related event has less impact on endpoints 125(1)-125(3) than when the event first occurred or was predicted to occur, the score may decrease. Conversely, if input 210 indicates that event has more impact on endpoints 125(1)-125(3) than when the event first occurred or was predicted to occur, the score may increase. Thus, the scoring may be ongoing and the score may change over time based on input 210.

The score may influence the specific set of recommendations defined to cope with the networking impact related event. For example, upon computing the score, proactive adjustment logic 150 may automatically identify one or more target adjustments based on the score. The target adjustments may include pre-configured static target adjustments and/or dynamic target adjustments to the network and/or to one or more of services 145(1)-145(6). For example, the score-to-recommendation translation may be statically configured by a user and/or dynamically determined based on the event.

Proactive adjustment logic 150 may automatically identify the one or more target adjustments based on a type of the networking impact related event. For instance, proactive adjustment logic 150 may provide different recommendations for an earthquake and a sporting event, even if the score is 7 for both events. In one specific example, the sporting event might prompt increased security/capabilities (e.g., 5G cell towers), whereas an earthquake may necessitate emergency capabilities.

The recommendations may be translated into actions within a specific environment/network. Examples of recommendations may include forwarding characteristics, auto-scaling parameters, and other relevant details that may help a network to properly cope with the networking impact related event. If the networking impact related event is temporary (e.g., a sporting event), the score may return to the value that was assigned before the networking impact related event was detected, the recommendations may be removed, the associated actions may be reversed, and the level of security (and/or other adjustments) may return to the state that was present before the networking impact related event was detected.

Proactive adjustment logic 150 may automatically identify one or more dynamic target adjustments based on feedback loop 220. Feedback loop 220 may include feedback on one or more previously implemented adjustments to the network and/or to one or more previously implemented services provided over the network (e.g., services 145(1)-145(6)). Feedback loop 220 may help proactive adjustment logic 150 improve score calculations and recommendations over time. Proactive adjustment logic 150 may obtain user feedback regarding the one or more previously implemented adjustments (e.g., by prompting the user for feedback regarding the service). Proactive adjustment logic 150 may also/alternatively automatically monitor networking impact related responses to the one or more previously implemented adjustments (e.g., by monitoring user behavior, traffic drops, etc.). Feedback loop 220 may correlate one or more of the score, set of recommendations, actual implementation, and actual implementation results to improve recommendations over time.

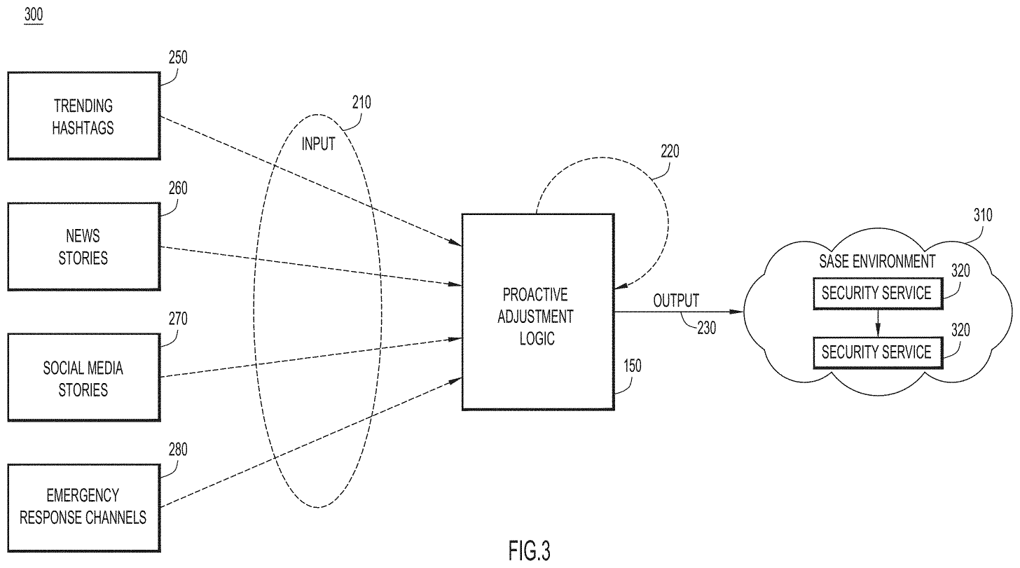

With continued reference to FIGS. 1 and 2, FIG. 3 illustrates an example functional workflow 300 in a SASE use case for providing an indication of one or more proactive target adjustments based on a networking impact related event that is occurring or will occur in a geographic region. Like in FIG. 2, proactive adjustment logic 150 obtains input 210, processes the input using feedback loop 220, and provides output 230. In this example, output 230 includes a set of recommendations provided to a SASE environment 310 (e.g., an edge cloud) to cope with a networking impact related event. Specifically, the set of recommendations are provided/interpreted as SASE rules that trigger autonomous/automatic changes in the SASE environment by moving security service 320 (e.g., an “as a service” security function) closer to one or more SASE enabled endpoints.

Proactive adjustment logic 150 may obtain input 210 (e.g., environmental/social media data) and consider the top-k stories/hashtags on one or more social media services (e.g., trending hashtags 250 and social media stories 270), news stories 260, and/or emergency details specific to a region or globally, depending on severity (e.g., emergency response channels 280). Based on input 210, proactive adjustment logic 150 may calculate the potential impact from a detected networking impact related event and cause SASE services to adjust accordingly based on an environmental score. As a result, proactive adjustment logic 150 may provide a set of recommendations (e.g., output 230) to SASE environment 310 to cope with the event.

Proactive adjustment logic 150 (e.g., an environmental SASE engine) may be installed on one or more SASE components (e.g., an edge router) configured to monitor networking impact related events in a geographic area or networking impact related event with wider (e.g., global) influence that may impact the geographic area. Based on the detected networking impact related event(s), proactive adjustment logic 150 may adapt SASE rules accordingly. Proactive adjustment logic 150 may obtain environmental information as input parameters, determine a level of impact to local SASE endpoints (e.g., using an artificial intelligence engine), and adjust SASE rules reflecting the detected event(s).

In one example, proactive adjustment logic 150 may provide output 230 (e.g., the score and the set of recommendations) to influence how specific destination URLs are to be accessed. For instance, in a geographic region struck by an earthquake, proactive adjustment logic 150 may prioritize network traffic from a website providing disaster information over network traffic from a URL that provides access to trivial entertainment videos. The techniques described herein are not necessarily limited to SASE use cases, and may apply to any suitable environment/architecture.

An example use case is now described in which the networking impact related event is a major sporting event (e.g., an auto race, a football game, etc.) that impacts a specific SASE-enabled edge cloud. Proactive adjustment logic 150 may detect the event based on one or more input parameters and determine an environmental score to describe the influence of the event on the SASE-enabled edge cloud. In this example, proactive adjustment logic 150 calculates an environmental score of 7, which indicates that the detected event has a high impact on the SASE-enabled edge cloud and the associated endpoints/users.

Based on the calculated score, proactive adjustment logic 150 determines a set of recommendations to provide to the SASE-enabled edge cloud to enable one or more demanded capabilities. In one specific example, the score of 7 may translate into recommendations to provide: (1) a Virtual Private Network (VPN) for every endpoint within the SASE-enabled edge cloud; (2) support for 10,000 users; and (3) advanced Uniform Resource Locator (URL) inspection. Providing a VPN for every endpoint may enable Internet access and/or additional security (e.g., encryption of traffic going into and out of a geographic region). Providing support for 10,000 users ensures there is sufficient support for the anticipated crowd. Providing advanced URL inspection may prevent users from accessing malicious URLs.

Proactive adjustment logic 150 may provide this set of recommendations to the SASE-enabled edge cloud, which may in turn translate the set of recommendations into actionable tasks. For example, to support 10,000 users, the SASE-enabled edge cloud may proactively scale a set of resources, such as Wide Area Network (WAN) connections, 5G capabilities, and services before the crowd has gathered. It will be appreciated that these recommendations and actionable tasks are merely examples; the techniques described herein may be compatible with any suitable number and/or type(s) of recommendations and/or actionable tasks.

Another example use case is now described in which the networking impact related event is an external event such as an earthquake that is or will impact servers hosting an e-commerce site. Instead of allowing the e-commerce site to go down, proactive adjustment logic 150 may provision (e.g., spin up) extra services and/or instances in another geographic region away from the earthquake before the e-commerce site goes down. Relocating the e-commerce site and/or adding extra services may ensure that the customers retain access to the e-commerce site and continue to experience high-quality service.

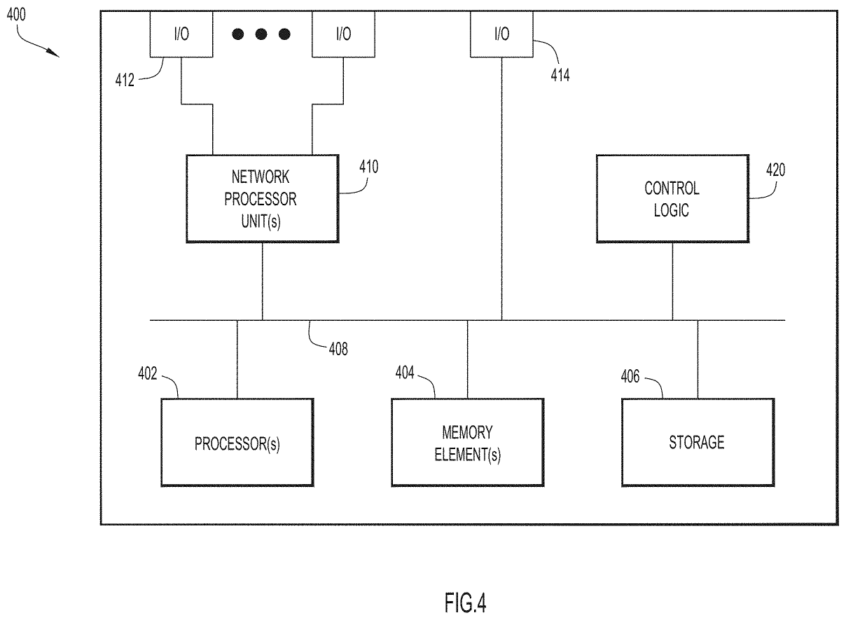

Referring to FIG. 4, FIG. 4 illustrates a hardware block diagram of a computing device 400 that may perform functions associated with operations discussed herein in connection with the techniques depicted in FIGS. 1-3. In various embodiments, a computing device, such as computing device 400 or any combination of computing devices 400, may be configured as any entity/entities as discussed for the techniques depicted in connection with FIGS. 1-3 in order to perform operations of the various techniques discussed herein.

In at least one embodiment, computing device 400 may include one or more processor(s) 402, one or more memory element(s) 404, storage 406, a bus 408, one or more network processor unit(s) 410 interconnected with one or more network input/output (I/O) interface(s) 412, one or more I/O interface(s) 414, and control logic 420. In various embodiments, instructions associated with logic for computing device 400 can overlap in any manner and are not limited to the specific allocation of instructions and/or operations described herein.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor.’

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory elements 404 (or vice versa), or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 410 may enable communication between computing device 400 and other systems, entities, etc., via network I/O interface(s) 412 to facilitate operations discussed for various embodiments described herein. In various embodiments, network processor unit(s) 410 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 412 can be configured as one or more Ethernet port(s), Fibre Channel ports, and/or any other I/O port(s) now known or hereafter developed. Thus, the network processor unit(s) 410 and/or network I/O interfaces 412 may include suitable interfaces for receiving, transmitting, and/or otherwise communicating data and/or information in a network environment.

I/O interface(s) 414 allow for input and output of data and/or information with other entities that may be connected to computing device 400. For example, I/O interface(s) 414 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 420 can include instructions that, when executed, cause processor(s) 402 to perform operations, which can include, but not be limited to, providing overall control operations of computing device 400; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), Application Specific Integrated Circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory elements 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to computing device 400 for transfer onto another computer readable storage medium.

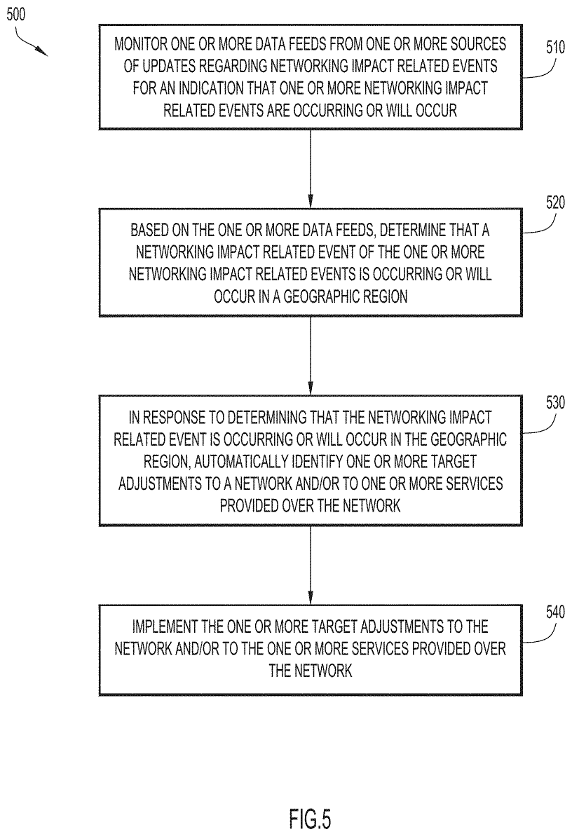

FIG. 5 is a flowchart of an example method 500 for performing functions associated with operations discussed herein. Method 500 may be performed by any suitable entity, such as edge device 130 or computing device 400 referred to above. Operation 510 includes monitoring one or more data feeds from one or more sources of updates regarding networking impact related events for an indication that one or more networking impact related events are occurring or will occur. Operation 520 includes determining, based on the one or more data feeds, that a networking impact related event of the one or more networking impact related events is occurring or will occur in a geographic region. Operation 530 includes automatically identifying, in response to determining that the networking impact related event is occurring or will occur in the geographic region, one or more target adjustments to a network and/or to one or more services provided over the network. Operation 540 includes implementing the one or more target adjustments to the network and/or to the one or more services provided over the network.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In one form, a method is provided. The method comprises: monitoring one or more data feeds from one or more sources of updates regarding networking impact related events for an indication that one or more networking impact related events are occurring or will occur; based on the one or more data feeds, determining that a networking impact related event of the one or more networking impact related events is occurring or will occur in a geographic region; in response to determining that the networking impact related event is occurring or will occur in the geographic region, automatically identifying one or more target adjustments to a network and/or to one or more services provided over the network; and implementing the one or more target adjustments to the network and/or to the one or more services provided over the network.

In one example, the method further comprises: based on the one or more data feeds, computing a score that indicates a level of criticality associated with the networking impact related event. In a further example, automatically identifying the one or more target adjustments is based on the score. In another further example, the method further comprises: after computing the score, continuing to monitor the one or more data feeds; and in response to continuing to monitor the one or more data feeds, adjusting the score.

In one example, automatically identifying the one or more target adjustments includes: automatically identifying one or more pre-configured static target adjustments to the network and/or to the one or more services provided over the network.

In one example, automatically identifying the one or more target adjustments includes: automatically identifying one or more dynamic target adjustments to the network and/or to the one or more services provided over the network. In a further example, automatically identifying the one or more dynamic target adjustments includes: automatically identifying the one or more dynamic target adjustments based on feedback on one or more previously implemented adjustments to the network and/or to one or more services previously provided over the network. In a still further example, automatically identifying the one or more dynamic target adjustments further includes: obtaining user feedback regarding the one or more previously implemented adjustments. In another still further example, automatically identifying the one or more dynamic target adjustments further includes: automatically monitoring network responses to the one or more previously implemented adjustments.

In one example, automatically identifying the one or more target adjustments is based on a type of the networking impact related event.

In one example, automatically identifying the one or more target adjustments includes: automatically identifying a target introduction of a security function of the one or more services.

In one example, automatically identifying the one or more target adjustments includes: automatically identifying a target relocation of a security function of the one or more services.

In one example, implementing the one or more target adjustments includes: providing the indication of the one or more target adjustments to one or more orchestrator processes that execute the one or more target adjustments.

In another form, an apparatus is provided. The apparatus comprises: a network interface configured to obtain or provide network communications; and one or more processors coupled to the network interface, wherein the one or more processors are configured to: monitor one or more data feeds from one or more sources of updates regarding networking impact related events for an indication that one or more networking impact related events are occurring or will occur; based on the one or more data feeds, determine that a networking impact related event of the one or more networking impact related events is occurring or will occur in a geographic region; in response to determining that the networking impact related event is occurring or will occur in the geographic region, automatically identify one or more target adjustments to a network and/or to one or more services provided over the network; and implement the one or more target adjustments to the network and/or to the one or more services provided over the network.

In another form, one or more non-transitory computer readable storage media are provided. The non-transitory computer readable storage media are encoded with instructions that, when executed by a processor, cause the processor to: monitor one or more data feeds from one or more sources of updates regarding networking impact related events for an indication that one or more networking impact related events are occurring or will occur; based on the one or more data feeds, determine that a networking impact related event of the one or more networking impact related events is occurring or will occur in a geographic region; in response to determining that the networking impact related event is occurring or will occur in the geographic region, automatically identify one or more target adjustments to a network and/or to one or more services provided over the network; and implement the one or more target adjustments to the network and/or to the one or more services provided over the network.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
monitoring one or more data feeds from one or more sources of updates regarding networking impact related events for an indication that one or more networking impact related events are occurring or will occur;
based on the one or more data feeds, determining that a networking impact related event of the one or more networking impact related events is occurring or will occur in a geographic region;
in response to determining that the networking impact related event is occurring or will occur in the geographic region, automatically identifying one or more target adjustments to a network and/or to one or more services provided over the network, including automatically identifying a target geographic relocation of a security function of the one or more services; and
implementing the one or more target adjustments to the network and/or to the one or more services provided over the network, including providing the indication of the one or more target adjustments to one or more orchestrator processes that execute the one or more target adjustments by moving the one or more services to preserve or improve a connectivity associated with the one or more services.

2. The method of claim 1, further comprising:
based on the one or more data feeds, computing a score that indicates a level of criticality associated with the networking impact related event.

3. The method of claim 2, wherein automatically identifying the one or more target adjustments is based on the score.

4. The method of claim 2, further comprising:
after computing the score, continuing to monitor the one or more data feeds; and
in response to continuing to monitor the one or more data feeds, adjusting the score.

5. The method of claim 1, wherein automatically identifying the one or more target adjustments further includes:
automatically identifying one or more pre-configured static target adjustments to the network and/or to the one or more services provided over the network.

6. The method of claim 1, wherein automatically identifying the one or more target adjustments further includes:
automatically identifying one or more dynamic target adjustments to the network and/or to the one or more services provided over the network.

7. The method of claim 6, wherein automatically identifying the one or more dynamic target adjustments includes:
automatically identifying the one or more dynamic target adjustments based on feedback on one or more previously implemented adjustments to the network and/or to one or more services previously provided over the network.

8. The method of claim 7, wherein automatically identifying the one or more dynamic target adjustments further includes:
obtaining user feedback regarding the one or more previously implemented adjustments.

9. The method of claim 7, wherein automatically identifying the one or more dynamic target adjustments further includes:
automatically monitoring networking impact related responses to the one or more previously implemented adjustments.

10. The method of claim 1, wherein automatically identifying the one or more target adjustments is based on a type of the networking impact related event.

11. The method of claim 1, wherein automatically identifying the one or more target adjustments further includes:
automatically identifying a target introduction of a security function of the one or more services.

12. (canceled)

13. (canceled)

14. An apparatus comprising:
a network interface configured to obtain or provide network communications; and
one or more processors coupled to the network interface, wherein the one or more processors are configured to:
monitor one or more data feeds from one or more sources of updates regarding networking impact related events for an indication that one or more networking impact related events are occurring or will occur;
based on the one or more data feeds, determine that a networking impact related event of the one or more networking impact related events is occurring or will occur in a geographic region;
in response to determining that the networking impact related event is occurring or will occur in the geographic region, automatically identify one or more target adjustments to a network and/or to one or more services provided over the network, including automatically identifying a target geographic relocation of a security function of the one or more services; and
implement the one or more target adjustments to the network and/or to the one or more services provided over the network, including providing the indication of the one or more target adjustments to one or more orchestrator processes that execute the one or more target adjustments by moving the one or more services to preserve or improve a connectivity associated with the one or more services.

15. The apparatus of claim 14, wherein the one or more processors are further configured to:
based on the one or more data feeds, compute a score that indicates a level of criticality associated with the networking impact related event.

16. The apparatus of claim 14, wherein the one or more processors are configured to:
automatically identify one or more pre-configured static target adjustments to the network and/or to the one or more services provided over the network.

17. The apparatus of claim 14, wherein the one or more processors are configured to:
automatically identify one or more dynamic target adjustments to the network and/or to the one or more services provided over the network.

18. One or more non-transitory computer readable storage media encoded with instructions that, when executed by a processor, cause the processor to:
monitor one or more data feeds from one or more sources of updates regarding networking impact related events for an indication that one or more networking impact related events are occurring or will occur;
based on the one or more data feeds, determine that a networking impact related event of the one or more networking impact related events is occurring or will occur in a geographic region;
in response to determining that the networking impact related event is occurring or will occur in the geographic region, automatically identify one or more target adjustments to a network and/or to one or more services provided over the network, including automatically identifying a target geographic relocation of a security function of the one or more services; and
implement the one or more target adjustments to the network and/or to the one or more services provided over the network, including providing the indication of the one or more target adjustments to one or more orchestrator processes that execute the one or more target adjustments by moving the one or more services to preserve or improve a connectivity associated with the one or more services.

19. The one or more non-transitory computer readable storage media of claim 18, wherein the instructions further cause the processor to:
based on the one or more data feeds, compute a score that indicates a level of criticality associated with the networking impact related event.

20. The one or more non-transitory computer readable storage media of claim 18, wherein the instructions cause the processor to:
automatically identify one or more pre-configured static target adjustments to the network and/or to the one or more services provided over the network.

21. The one or more non-transitory computer readable storage media of claim 18, wherein the instructions cause the processor to:
automatically identify one or more dynamic target adjustments to the network and/or to the one or more services provided over the network.

22. The apparatus of claim 15, wherein the one or more processors are configured to:
automatically identify the one or more target adjustments based on the score.
